(19) United States
(12) Patent Application Publication
(10) Pub. No.: US 2014/0330701 A1
(43) Pub. Date: Nov. 6, 2014

(54) Methods and Systems for Chart Based Order Entry

(71) Applicant: Realtick LLC, Chicago, IL (US)

(72) Inventors: Stuart Townsend, Chicago, IL (US); Derek Lance Gover, Glencoe, IL (US); Christina Sciotto, Chicago, IL (US); Arthur A. Woerheide, New York, NY (US)

(21) Appl. No.: 14/334,896

(22) Filed: Jul. 18, 2014

Related U.S. Application Data
(63) Continuation of application No. 11/731,818, filed on Mar. 29, 2007, now abandoned.
(60) Provisional application No. 60/787,611, filed on Mar. 29, 2006.

(51) Int. Cl. G06Q 40/04

(52) U.S. Cl. CPC G06Q 40/04
USPC 705/37

(57) ABSTRACT

In one aspect, the invention comprises software comprising: (a) software for displaying a chart display comprising pricing information for securities; and (b) software for displaying an interface display for placing securities orders, wherein the chart display is configured to enable a user to enter price information in the interface display by selecting a location on the chart display corresponding to a price to be entered into the interface display. In another aspect, the invention comprises a method comprising entering price information in an interface display for placing securities orders by selecting a location on a chart display comprising pricing information for securities, the location corresponding to a price to be entered into the interface display.

### CROSS REFERENCE TO RELATED APPLICATIONS

This application claims priority to U.S. Provisional Patent Application No. 60/787,611, filed Mar. 29, 2006. The entire contents of that provisional application are incorporated herein by reference.

### BACKGROUND AND SUMMARY

Townsend Analytics, Ltd. (“TAL”) connects directly to market data sources, including exchanges and primary dealers. Through these connections TAL receives real-time streaming quote data on multiple asset classes that is processed and distributed across TAL's quote server farm using TAL technology. See FIG. 1.

RealTick, TAL's graphical user interface used by professional and retail traders to view, analyze, and trade securities across multiple asset classes, connects to TAL's quote server farm through the Internet, dedicated lines, or financial extranets such as Radianz. When a trader requests data on a ticker symbol, RealTick sends the request to the server farm and returns and displays the data on its user interface.

Chapter 1 (Introduction) and the first portion of Chapter 7 (Placing Orders) of the RealTick User Manual are incorporated herein by reference for background purposes. The User manual is available at www dot realtick dot com/v2_filesktuserman.pdf.

Once the data request is made and displayed, a trader may act on that data by placing an order. RealTick sends the order to TAL's service bureau. The service bureau is a full-service IT solution that supports electronic trading by offering risk and compliance management and mid-to back-office solutions. The service bureau's network offers connectivity to electronic exchanges, other brokers, and a variety of order management systems.

After the trading system performs its validity checks on the order, the trading system sends the order to TAL's final software component within its network, the exchange handlers. Exchange handlers receive the order and translate it from TAL's internal protocol into to the protocol of the exchange.

The execution reports generated by the exchanges return back through the exchange handler, the service bureau, and finally back to RealTick, which displays the status of the order back to the trader.

An embodiment of the present invention comprises software for providing a graphical user interface for use in securities trading. As explained in the Detailed Description below, a user of the software is able to place or change an order by clicking or dragging on a displayed chart of market conditions.

For example, if a user clicks a price level in a chart, that price is automatically entered into an order entry screen. See “Place an Order” below.

An order may be changed by, for example, clicking and dragging the displayed order to a desired price level. See “Change an Order” below.

In one aspect, the invention comprises software comprising: (a) software for displaying a chart display comprising pricing information for securities; and (b) software for displaying an interface display for placing securities orders, wherein the chart display is configured to enable a user to enter price information in the interface display by selecting a location on the chart display corresponding to a price to be entered into the interface display.

In various embodiments: (1) the pricing information is displayed on a vertical axis in the chart display; (2) the chart display is further configured to display an open securities order on a horizontal line at a vertical location corresponding to a price for the open order; (3) the chart display is further configured to display a net position of a selected account on a horizontal line at a vertical location corresponding to an average price for the net position; (4) the chart display comprises a display tool that displays to a user pricing information for a selected vertical location on the chart display; (5) the interface display comprises fields for placing orders, the fields comprising a price field, wherein when a user selects the location on the chart display, the price field is filled with a price corresponding to the location; (6) the chart and interface displays are configured to allow a user to change an open order by moving the horizontal line; (7) the chart and interface displays are configured to allow a user to change an open order by moving the horizontal line with a mouse cursor; (8) the horizontal line at a vertical location corresponding to a price for the open order has a color different from a color used for a horizontal line at a vertical location corresponding to an average price for the net position; and (9) the horizontal line at a vertical location corresponding to a price for the open order is red, and the horizontal line at a vertical location corresponding to an average price for the net position is green.

In another aspect, the invention comprises a method comprising entering price information in an interface display for placing securities orders by selecting a location on a chart display comprising pricing information for securities, the location corresponding to a price to be entered into the interface display.

In various embodiments: (1) the pricing information is displayed on a vertical axis in the chart display; (2) the chart display is configured to display an open securities order on a horizontal line at a vertical location corresponding to a price for the open order; (3) the chart display is configured to display a net position of a selected account on a horizontal line at a vertical location corresponding to an average price for the net position; (4) the chart display comprises a display tool that displays to a user pricing information for a selected vertical location on the chart display; (5) the interface display comprises fields for placing orders, the fields comprising a price field, and the method further comprises filling the price field with a price corresponding to the location by selecting the location on the chart display; (6) the method further comprises changing an open order by moving the horizontal line; (7) the horizontal line is moved using a mouse cursor; (8) the horizontal line at a vertical location corresponding to a price for the open order has a color different from a color used for a horizontal line at a vertical location corresponding to an average price for the net position; and (9) the horizontal line at a vertical location corresponding to a price for the open order is red, and the horizontal line at a vertical location corresponding to an average price for the net position is green.

Other examples are described in the attached description or will be apparent to those skilled in the art.

Although the present invention is described in the context of RealTick and TAL's order management system, those skilled in the art will recognize that the invention may be used in conjunction with any other comparable order entry software and order management system.

Embodiments of the present invention comprise computer components and computer-implemented steps that will be apparent to those skilled in the art. For ease of exposition, not every step or element of the present invention is explicitly described herein as part of a computer system, but those skilled in the art will recognize that each step or element may have, and preferably does have, a corresponding computer system or software component. Such computer system and/or software components are therefore enabled by describing their corresponding steps or elements (that is, their functionality), and are within the scope of the present invention.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 depicts TAL's trading system.

FIG. 2 depicts a chart design menu of an embodiment.

FIGS. 3-15 depict screens of a chart setup interface for an embodiment.

FIG. 16 depicts an order chart of an embodiment.

FIGS. 17-7 depict screens of an order entry chart of an embodiment.

FIG. 28 shows a crosshairs tool of an embodiment.

FIGS. 29-30 illustrate how an order is changed in an embodiment.

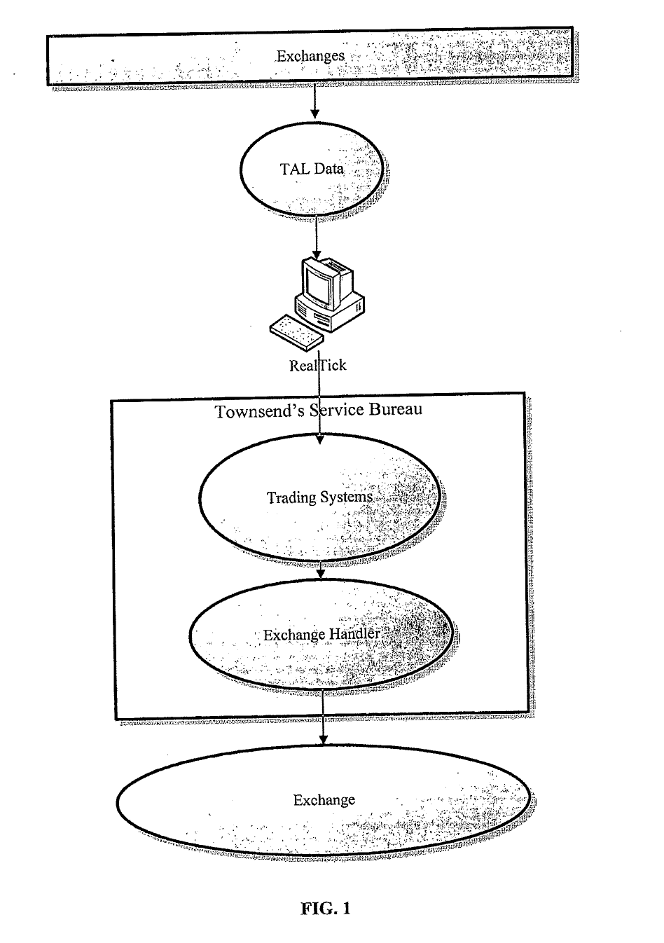

### DETAILED DESCRIPTION

The following description describes software, steps, and graphical user interfaces of at least one embodiment of the present invention.

Create a Chart

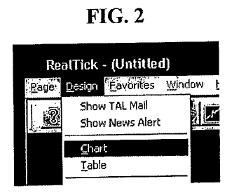

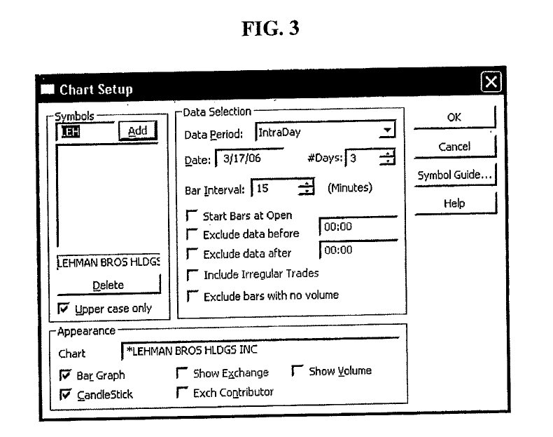

In order to create a chart, a user clicks Chart on a RealTick Design menu. See FIG. 2.

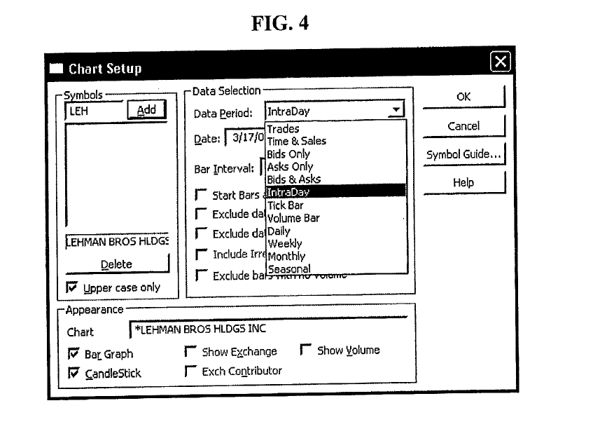

Next, the user enters one or more symbols into the Symbols field of a Chart Setup menu. See FIG. 3. The user also chooses the type of chart desired from a drop-down list available in a Data Period field. See FIG. 4.

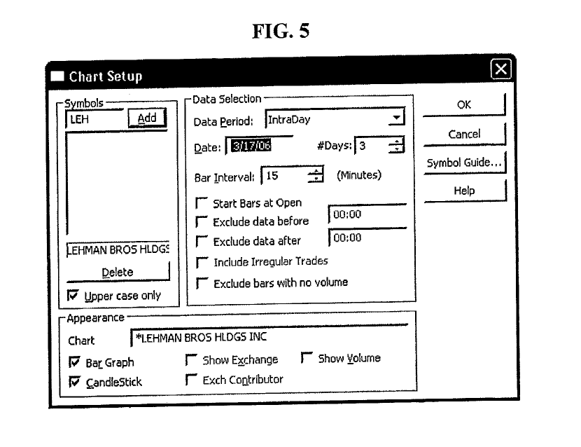

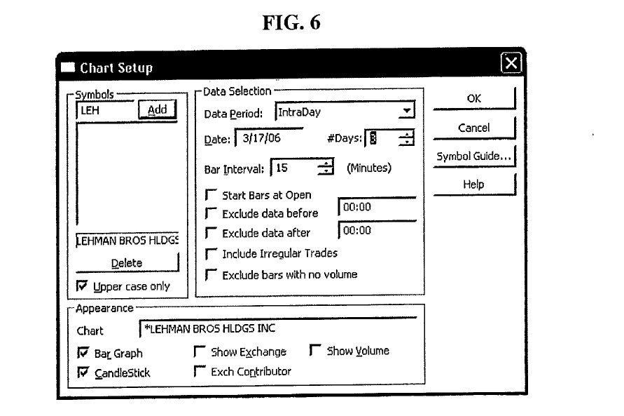

The user also enters a date in a Date field. By default, the field preferably contains the current date. See FIG. 5. The user also specifies the number of days to go back in a Days field. See FIG. 6.

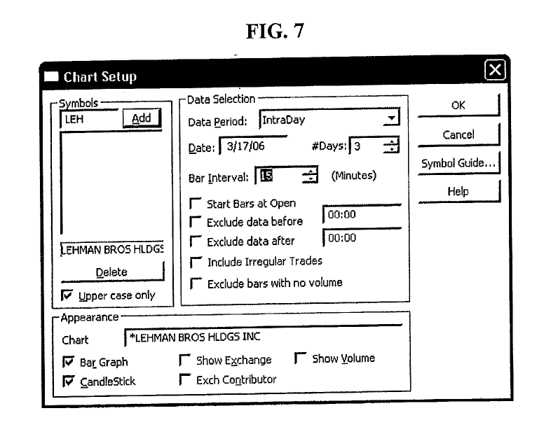

If the user creates an Intraday chart, the user types a numeric value for the minute time interval in an Intraday Bar Interval field, or uses arrows to increase or decrease the value. The system updates the information at each interval. See FIG. 7.

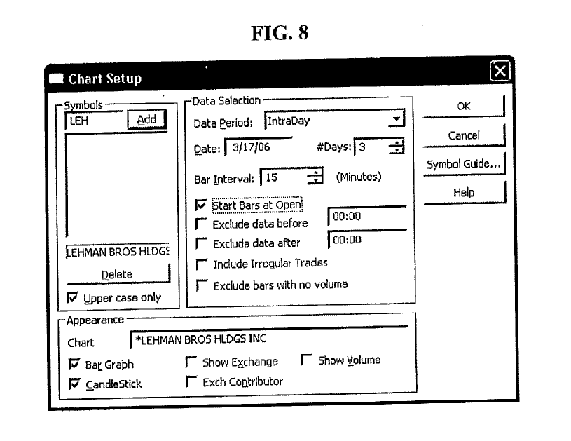

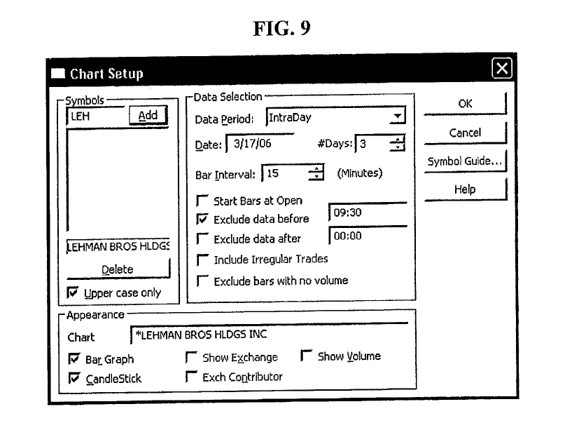

A user checks Start Bars at Open to display data only from the current day's market open. See FIG. 8. A user checks Exclude Data Before to exclude the display of data before a specified time. See FIG. 9. Checking this box preferably disables Start Bars at Open.

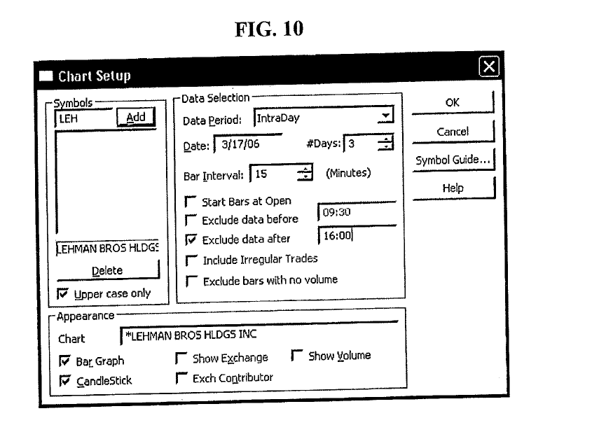

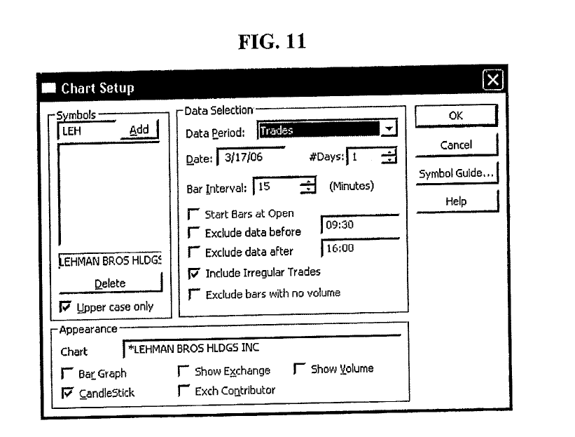

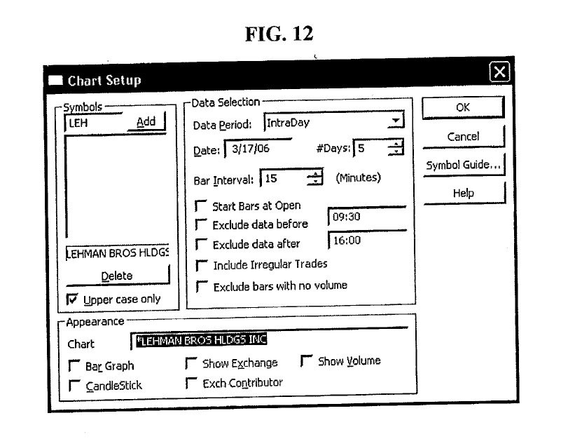

A user checks Exclude Data After to exclude the display of data after a specified time. See FIG. 10. A user checks Include Irregular Trades to display irregular data such as pre- and post-market activity, as well as trades that were executed away from the best bid or best offer. See FIG. 11. This option preferably is available for the following data periods: Trades, Time & Sales, Tick Bar, and Volume Bar.

A user may type a title for the chart in a Chart Title field. By default, the title will be the company name of the symbol entered into the Chart. See FIG. 12. The presence of the asterisk (*) as a wildcard character ensures that the title will update when the symbol in the Chart is changed.

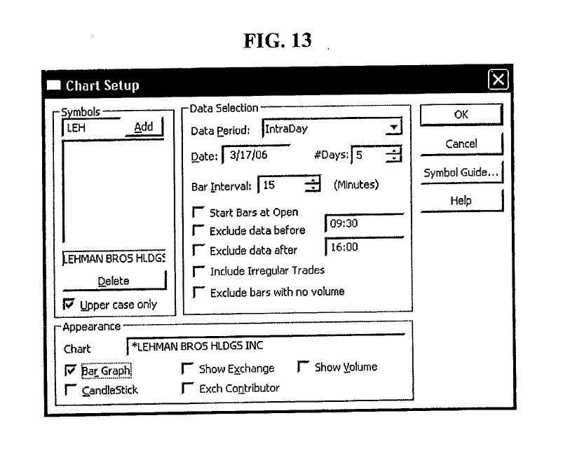

A user clicks a Bar Graph check box to display the chart data in a bar graph. This preferably is available for the following intervals: Intraday, Tick Bar, Volume Bar, Daily, Weekly, and Monthly. See FIG. 13.

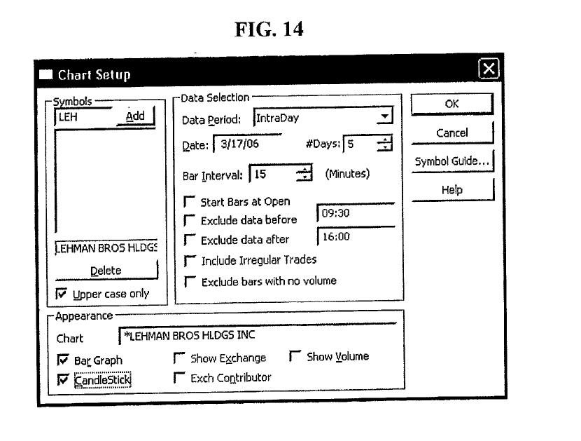

A user clicks a Candlestick check box to display a candlestick interval chart. This preferably is available only when Bar Graph is checked. See FIG. 14.

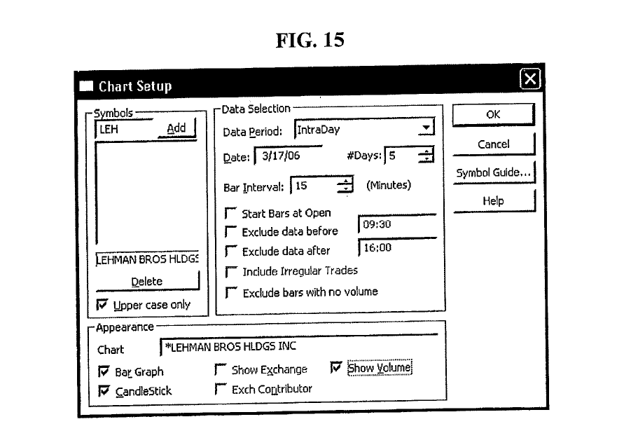

A user clicks a Show Volume check box to display a volume bar graph, and then clicks OK to display the Chart. See FIG. 15.

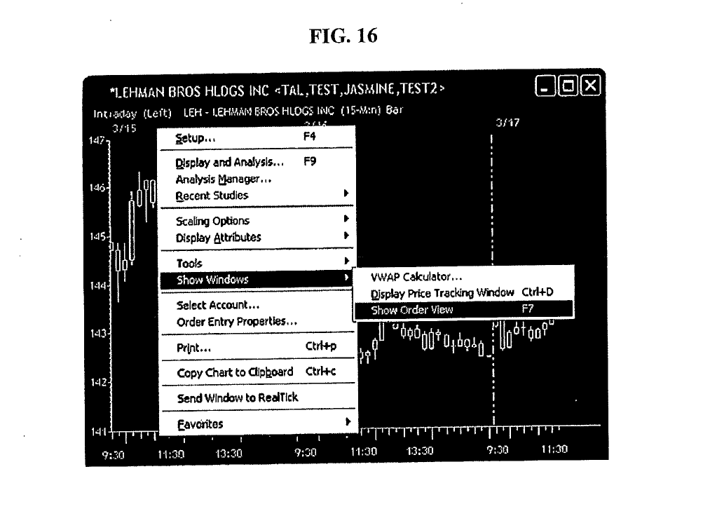

On the displayed Chart (see FIG. 16), the user can click the Chart menu and choose Show

Order View from the Show Windows sub-menu to attach the Order Entry Screen to the bottom of the Chart. Aside from using the Chart menu, the user also can display the Order Entry Screen by pressing the F7 function key.

Place an Order

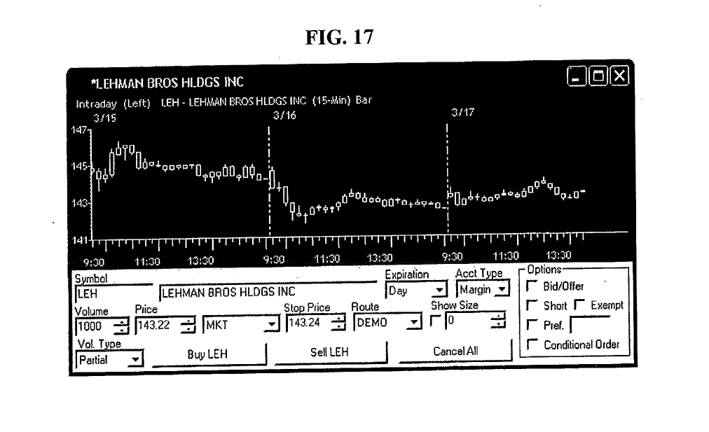

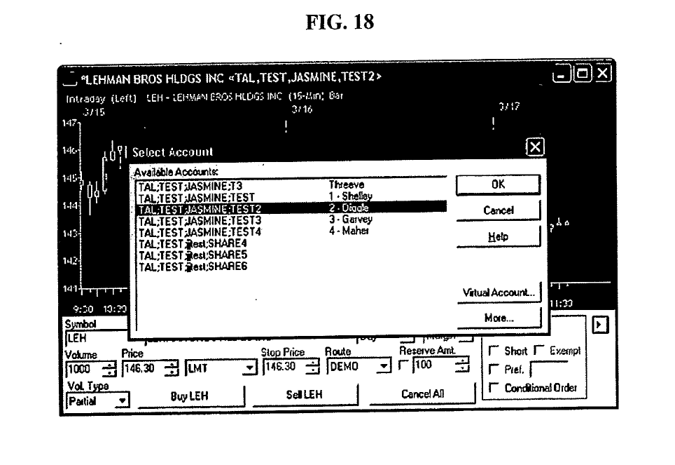

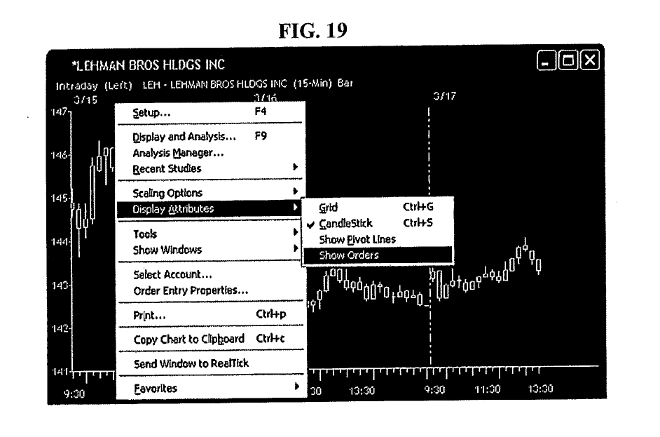

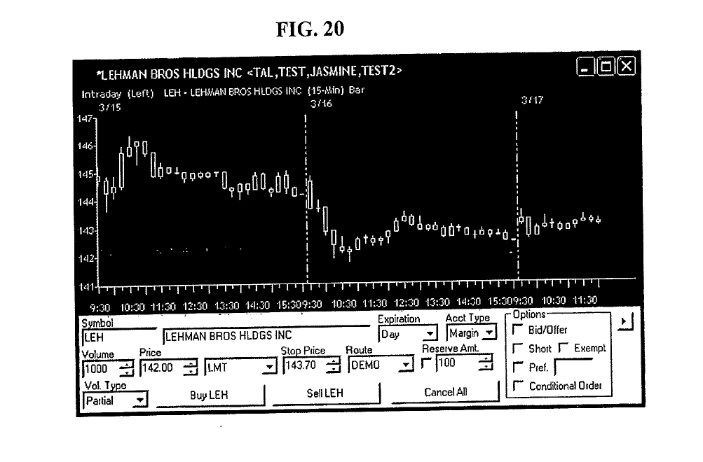

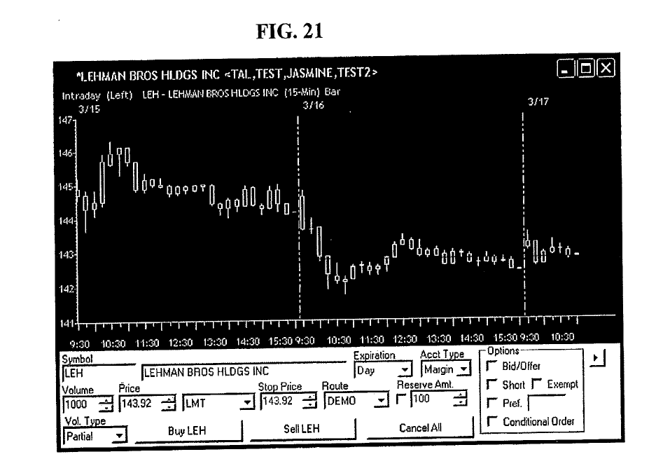

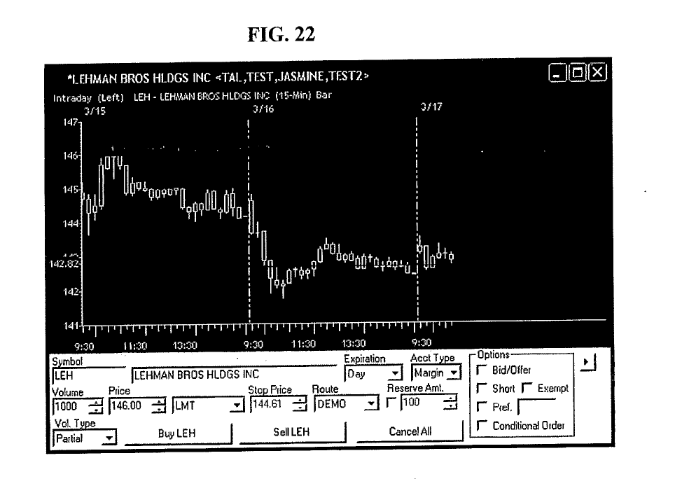

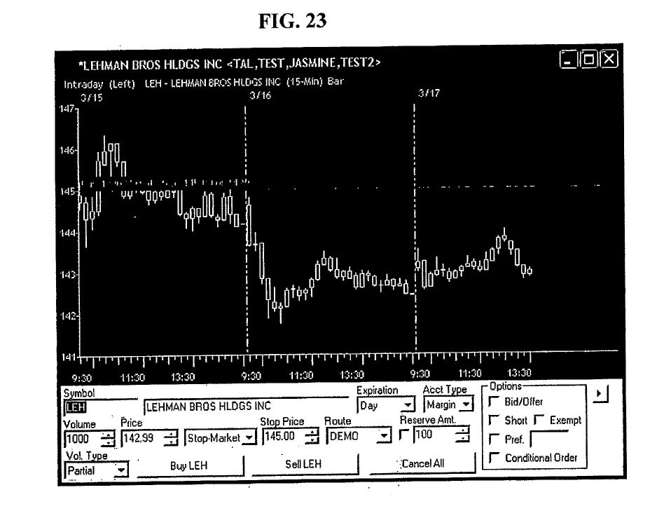

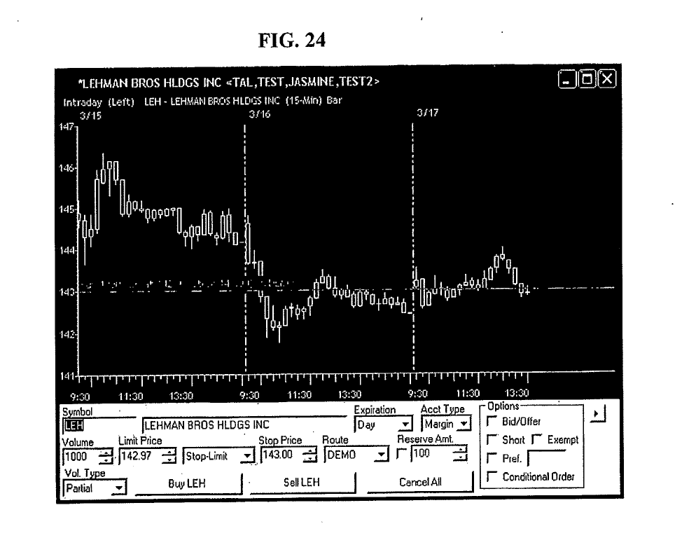

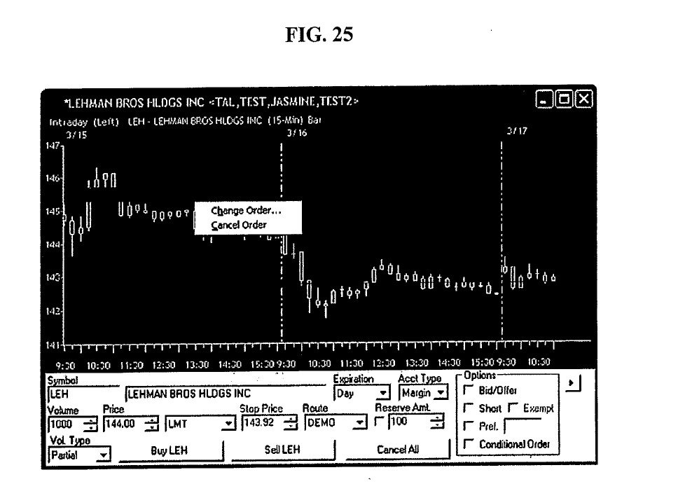

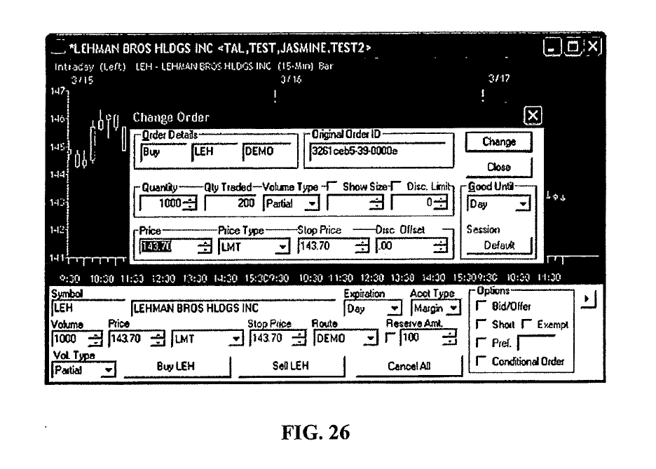

FIG. 17 depicts an Order Entry Screen of an embodiment, with a standard layout. The vertical bars are used to indicate prices. “Up” bars are shown in green; “down” bars are shown in red. Tops and bottoms of bars (or “candlesticks”) mark opening and closing price for the period; the “wicks” mark high and low prices for the period. “Up” and “down” refer to whether the opening price was higher than the closing price (“up” meaning that the closing price was higher than the opening price).

If an account has not already been selected, or if a user wishes to change the selected account, the user clicks the Chart menu and chooses Select Account to specify the trading account in which the order will be placed. See FIG. 18.

A user preferably also is able to customize the display. For example, FIG. 19 shows that “Candlestick” has been selected for the chart display.

In the Order Entry Screen, the user configures the remaining parameters of the order to be placed: Expiration, Acct Type, Volume, Price, Price Type, Route, Reserve Amt (if placing a Reserve Order), and Vol. Type. These fields preferably remain unchanged from one order to the next, unless changed by the user.

To place an order, the user clicks the Chart to fill in the Price field in the Order Entry Screen (see FIG. 17). For example, the user clicking on the screen at a point on the same vertical level as 146.30 results in that price being pre-filled in the Price box of the Order Entry Screen. See FIG. 18.

The user clicks the Buy or Sell buttons to execute. All live orders for the symbol preferably can be canceled by clicking a Cancel All button.

Display Orders in a Chart

Orders and positions may be displayed for a symbol currently displayed in a Chart. A user clicks the Chart menu and chooses Show Orders from the Display Attributes sub-menu. See FIG. 19. The Show Orders option may be de-selected in order to not have orders displayed—but the feature of filling order price by clicking at a vertical position on the display preferably remains enabled.

While there is no restriction to the type of live order that can be displayed in a Chart, preferably only open positions are shown. Once a position is closed, or the order is canceled, it will not display in the Chart window. FIGS. 20-24 depict some examples of live orders and open positions as displayed in a Chart window.

FIG. 20 depicts a live order: LMT Buy 1000 LEH on route DEMO. The horizontal red line, along with the red text immediately above that line, allow a user to quickly view the nature of the order (“Buy 1000 LEH at 142.00 on DEMO”), and the vertical location of the line and text quickly show the user the price of the order. The red color (user-configurable) denotes that the order is live.

FIG. 21 depicts a long position: 1000 LEH bought at an average price of 142.797. The green horizontal line and associated text convey to the user the nature of the position (“Long 1000 LEH”), and the average price is conveyed both by the text and by the vertical location of the line. The green color (user-configurable) denotes that this is a position (in this case, a filled order). Preferably, only net positions are displayed in this manner—not all positions. However, this is subject to user configuration.

FIG. 22 depicts a long position and a live order: 2800 LEH bought at an average price of 142.676 with a live order of 200 shares remaining. The red color of the order shows that it is only partially filled.

FIG. 23 depicts a stop order: Buy 1000 LEH on route DEMO (stop: 145.00). FIG. 24 depicts a stop-limit order: Buy 1000 LEH at 142.97 on route DEMO (stop: 143.00).

Change an Order

While an order is live, a user has several options to change the order. The user can left-click and drag the order to the desired (new) price level, and then release to change the order. Doing this preferably does not bring up a Change Order dialog box, since it is presumed that the user wants to change the price only.

Alternatively, the user can right-click the order and choose “Change Order . . . ” to bring up a Change Order dialog box, or can choose “Cancel Order” and then acknowledge a “Confirm Cancel” message. See FIG. 25.

Clicking “Change Order . . . ” brings up a Change Order dialog box. See FIG. 26. A user clicks Yes to continue with the change, or No to cancel the change. See FIG. 27. If Confirmations are disabled in Order Entry Properties, changes and cancellations preferably will complete without the dialog.

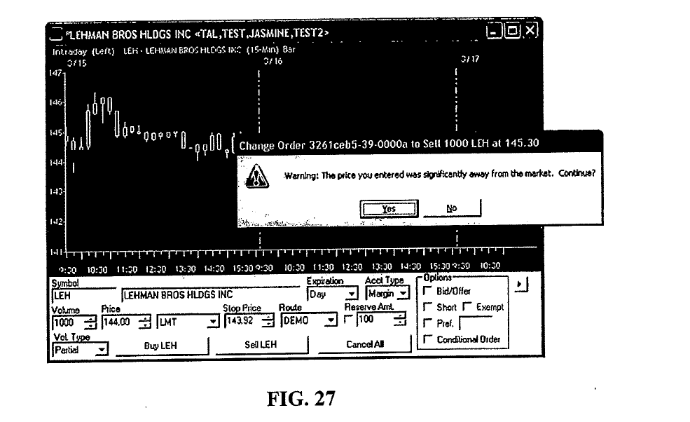

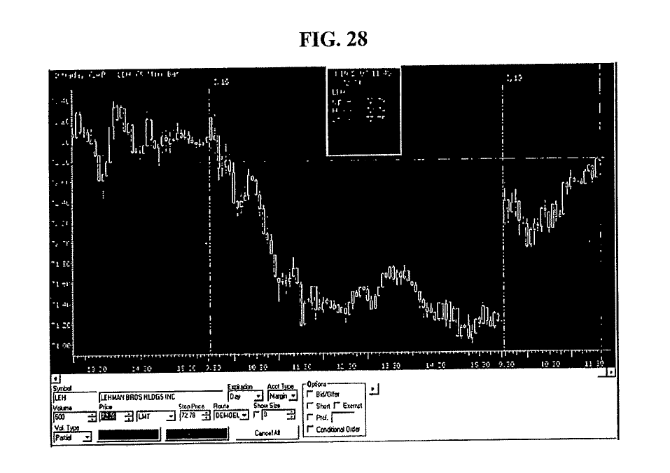

FIG. 28 is a screenshot showing a crosshair tool of an embodiment being used to set the price more precisely. The crosshair tool preferably is activated by clicking on the chart and holding the mouse button down. As the cursor location changes, the detailed pricing information shown in the crosshair tool display box changes, according to vertical location on the display.

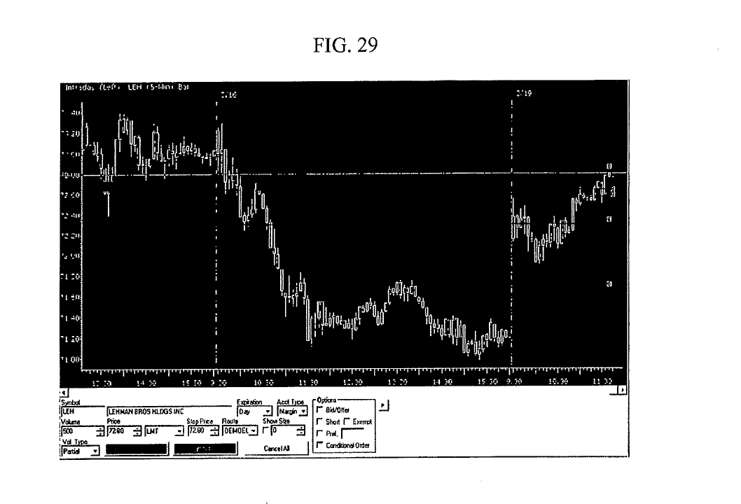

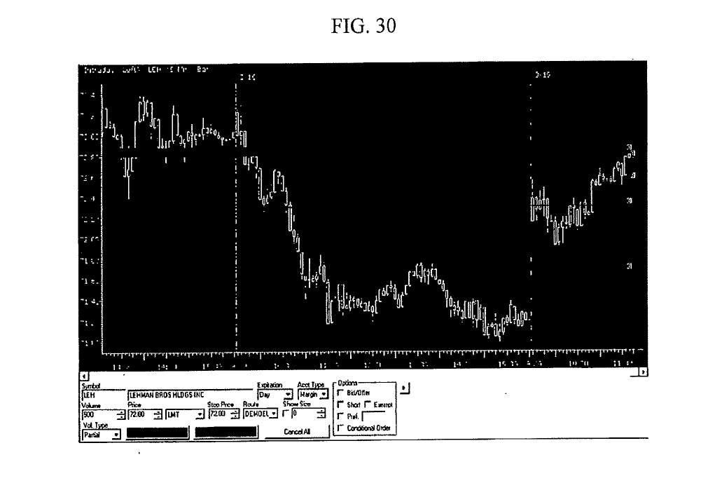

FIG. 29 shows a live order being changed via dragging the line with the mouse (the white line is where the order will be when the mouse button is released). The cursor preferably is changed to up-down arrows (not shown) when the order is being changed. FIG. 30 shows the result of the order change.

The above-described aspects and embodiments are not intended to be limiting. Those skilled in the art will perceive other aspects and embodiments after reviewing the drawings and the detailed description.

Embodiments of the present invention comprise computer components and computer-implemented steps that will be apparent to those skilled in the art. For ease of exposition, not every step or element of the present invention is described herein as part of a computer system, but those skilled in the art will recognize that each step or element may have a corresponding computer system or software component. Such computer system and/or software components are therefore enabled by describing their corresponding steps or elements (that is, their functionality), and are within the scope of the present invention.

1. A computer program product including a computer readable medium having stored thereon computer executable instructions that, when executed by a computer, direct the computer to perform a method comprising the steps of:
displaying a chart display comprising pricing information for securities wherein said pricing information is displayed on a vertical axis in said chart display; and
displaying an interface display for placing securities orders,
wherein:
said chart display is configured to enable a user to enter price information in said interface display by selecting a location on said chart display corresponding to a price to be entered into said interface display,
said chart display is further configured to display one or more parameters of an open securities order on a first horizontal line at a vertical location corresponding to a price for said open order and to display one or more parameters of a net position of a selected account on a second horizontal line at a vertical location corresponding to an average price for said net position,
said chart and interface displays are further configured to allow a user to perform actions comprising one or more of: (a) changing an open order by using said first horizontal line and (b) cancelling an open order by using said first horizontal line, and
said chart and interface displays are configured to allow a user to change an open order automatically by dragging with a mouse cursor said first horizontal line from a first price position to a second price position on the chart display.

2. (canceled)

3. (canceled)

4. (canceled)

5. The computer program product of claim 1, wherein said chart display comprises a display tool that displays to a user pricing information for a selected vertical location on said chart display.

6. The computer program product of claim 1, wherein said interface display comprises fields for placing orders, said fields comprising a price field, wherein when a user selects said location on said chart display, said price field is filled with a price corresponding to said location.

7. (canceled)

8. (canceled)

9. The computer program product of claim 1, wherein said first horizontal line at a vertical location corresponding to a price for said open order has a color different from a color used for said second horizontal line at a vertical location corresponding to an average price for said net position.

10. The computer program product of claim 9, wherein said first horizontal line at a vertical location corresponding to a price for said open order is red, and said second horizontal line at a vertical location corresponding to an average price for said net position is green.

11. A method comprising:
entering, via a computer, price information in a computer system interface display for placing securities orders by selecting a location on a chart display comprising pricing information for securities, said location corresponding to a price to be entered into said interface display, wherein said pricing information is displayed on a vertical axis in said chart display;
displaying, in said chart display, one or more parameters of an open securities order on a first horizontal line at a vertical location corresponding to a price for said open order via the computer;
displaying, in said chart display, apparatus for performing actions comprising one or more of: (a) changing said open order by using said first horizontal line and (b) cancelling said open order by using said first horizontal line;
displaying, in said chart display, one or more parameters of a net position of a selected account on a second horizontal line at a vertical location corresponding to an average price for said net position via the computer; and
displaying, in said chart display, apparatus for changing an open order automatically by dragging said first horizontal line from a first price position to a second price position on the chart display.

12. (canceled)

13. (canceled)

14. (canceled)

15. A method as in claim 11, wherein said chart display comprises a display tool that displays to a user pricing information for a selected vertical location on said chart display.

16. A method as in claim 11, wherein said interface display comprises fields for placing orders, said fields comprising a price field, and further comprising filling said price field with a price corresponding to said location by selecting said location on said chart display.

17. (canceled)

18. A method as in claim 11, wherein said first horizontal line is dragged using a mouse cursor.

19. A method as in claim 11, wherein said first horizontal line at a vertical location corresponding to a price for said open order has a color different from a color used for said second horizontal line at a vertical location corresponding to an average price for said net position.

20. A method as in claim 19, wherein said first horizontal line at a vertical location corresponding to a price for said open order is red, and said second horizontal line at a vertical location corresponding to an average price for said net position is green.
